(19) United States
(12) Patent Application Publication
(10) Pub. No.: US 2006/0225428 A1
(43) Pub. Date: Oct. 12, 2006

(54) Dual fuel combined cycle power plant

(76) Inventor: Joseph Brostmeyer, Jupiter, FL (US)

Correspondence Address: Joseph Brostmeyer;Florida Turbine Technologies, Inc., Suite 301, 140 Intracoastal Pointe Drive, Jupiter, FL, 33477, US

(21) Appl. No.: 11/176,163

(22) Filed: Jul. 7, 2005

Related U.S. Application Data
(60) Provisional application No. 60/668,985, filed on Apr. 7, 2005.

(51) Int. Cl. F02C 3/26

(52) U.S. Cl. 60/772; 60/39.464

(57) ABSTRACT

A power plant that includes two combustors in which a particulate containing fuel like coal is burned in one combustor and a non-particulate or clean fuel is burned in the other combustor, and where a heat exchanger is sued to transfer heat from the particulate combustion process to compressed air stream leading into the non-particulate combustor. The outlet from the heat exchanger containing the particulate combustion product is delivered to a heat recovery steam generator to produce steam and drive a turbine. The non-particulate combustion product from is used to drive a second turbine, and the outlet from the turbine is delivered to the inlet of the particulate combustor to be mixed with a particulate containing fuel. The invention allows for the use of a relatively cheap fuel such as coal to be used in a gas turbine power producing plant.

### CROSS-REFERENCE TO RELATED APPLICATIONS

This application claims the benefit to co-pending U.S. Provisional Application No. 60/668,985 filed on Apr. 07, 2005.

### BACKGROUND OF THE INVENTION

1. Field of the Invention

The present invention relates to a gas turbine power plant in which two distinct fuels are used to produce steam delivered to the turbines.

2. Description of the Related Art including information disclosed under 37 CFR 1.97 and 1.98

Coal has been used as a fuel source in power plants that produce steam, the steam being used to drive a turbine and produce electrical power. The efficiency of a gas turbine engine is related to the temperature of the gas flow into the turbine. Higher gas temperatures result in higher efficiencies. Coal can produce very high temperatures in the resulting gas stream. However, the coal exhaust contains fine particulate matter and corrosive residue that can damage turbines. One theoretical solution to this problem is to use a heat exchanger to transfer heat from the coal gas stream to a gas turbine stream. However, modern metal heat exchangers cannot operate at high enough temperatures to makes this practical. The use of ceramic heat exchangers has been considered, since ceramic materials can withstand higher temperatures than modern metallic materials. However, ceramic heat exchangers do not have high heat transfer rates (as compared to metal material heat exchangers) to make this practical, or the cost of the ceramic material heat exchangers are very high and therefore prohibitive for use as a cost effective alternative to metal heat exchangers. With the price of petroleum relate fuels rising, there is a continuing need to use coal as a fuel source to drive a gas turbine engine. The present invention attempts to solve the problem of using a metallic material heat exchanger and a coal fired combustor to produce a gas stream for a gas turbine engine in order to produce electrical power.

U.S. Pat. No. 2,401,285 issued to Woodward et al on May 28, 1946 shows a gas turbine system which uses two distinct fuels and a heat exchanger to transfer heat from one of the burners to a gas flow leading into a turbine, but unlike the present invention the Woodward invention does not produce power from the gas flow out of the main furnace. In the Woodward invention, the main furnace is used to provide heat to dry the fuel (garbage with high moisture content) fed to this main furnace.

U.S. Pat. No. 2,691,271 issued to McDevitt on Oct. 12, 1954 shows a waste heat power plant including an air turbine cycle that burns a high moisture content fuel and an oil or gas based fuel is burned in the same boiler to produce a continuous and substantially uniform stream of high temperature gaseous products of combustion which are utilized for the preheating to a high temperature of compressed air subsequently expanded through an air turbine for the generation of electric power, the high temperature exhaust air from the turbine being utilized for the rapid drying and burning of the primary solid fuel and burning of the supplementary fuel.

U.S. Pat. No. 5,704,206 issued to Kaneko et al on Jan. 6, 1998 shows a coal burner combined power plant includes a gas turbine for burning coal in a furnace under the pressure and uses produced gas. A steam turbine is combined with an exhaust gas boiler using exhaust gas from the gas turbine. Another fuel is burned at an inlet of the gas turbine for allowing the temperature at the inlet of the gas turbine to rise. A fuel reformer reforms the other fuel and is located within the furnace. In the Kaneko patent, the non-coal combustion product is not delivered from a turbine into the coal burning combustor, and two heat exchangers are used.

U.S. Pat. No. 6,640,548 issued to Brushwood et al on November 2003 shows a gas turbine (12) capable of combusting a low quality gaseous fuel having a ratio of flammability limits less than 2, or a heat value below 100 BTU/SCF. A high quality fuel is burned simultaneously with the low quality fuel to eliminate instability in the combustion flame. A sensor (46) is used to monitor at least one parameter of the flame indicative of instability. A controller (50) having the sensor signal (48) as input is programmed to control the relative flow rates of the low quality and high quality fuels. When instability is detected, the flow rate of high quality fuel is automatically increased in relation to the flow rate of low quality fuel to restore stability.

U.S. Pat. No. 6,640,548 issued to Baardson on Apr. 27, 1982 shows an indirect gas turbine power plant is provided which includes primary and secondary combustors wherein fuel is burned and heat is conveyed to a turbine working medium which is subsequently passed through the turbine section of a gas turbine. The gas turbine includes both a compressor section and a turbine section. The primary combustor has a first inlet for receiving exhaust air from the turbine section, a second inlet for receiving fuel and an outlet for the discharge of products of combustion. The secondary combustor includes a first inlet for receiving at least a portion of the products of combustion from the primary combustor, a second inlet for receiving a portion of the products of combustion of the secondary combustor, and an outlet for the discharge of the products of combustion of the secondary combustor. An air heat exchanger for conveying heat from the products of combustion to the compressed air is positioned within the secondary combustor. This heat exchanger includes an inlet for receiving compressed air from the compressor section of the gas turbine, and an outlet to direct the compressed, hot air out of the secondary combustor for passage to the turbine section.

U.S. Pat. No. 5,934,065 issued to Bronicki et al on Aug. 10, 1999 shows an apparatus for generating power includes a gas turbine unit having a compressor for compressing ambient air and producing compressed air, a combustion chamber to which the compressed air is supplied, a source of relatively high grade fuel for burning in the combustion chamber and producing combustion gases, and a gas turbine connected to generator and to the compressor for expanding the combustion gases and producing exhaust gases. The apparatus further includes a combustor that burns relatively low grade fuel, and produces combustion products, and an indirect contact heat exchanger responsive to the combustion products for heating the compressed air before the latter is applied to the combustion chamber, and for producing cooled combustion products. In addition, an energy converter is provided having an organic working fluid responsive to the exhaust gases for converting heat in the exhaust gases to electricity. Finally, the apparatus of the invention serves to minimize the consumption of high grade fuel in the presence of changes in the heating value of the low grade fuel.

U.S. Pat. No. 5,934,065 issued to Rice on Jan. 30, 1990 show a compression intercooled gas turbine and vapor bottoming combined cycle system with the gas turbine operating at 30 to 65 atmospheres is disclosed. A twin spool hot gas generator incorporates compression intercooling at the optimum intercooler pressure ratio to (a) minimize intercooler heat rejection degradation, (b) raise the overall cycle pressure ratio, (c) increase gas generator core mass flow and (d) to increase the gas turbine power output. The gas turbine can operate in either the simple cycle or the reheat cycle mode for optimum combined cycle efficiency.

U.S. Pat. No. 5,934,065 issued to Smith on Jul. 15, 1997 shows a combined-cycle multi-pressure reheat system employs a plurality of power generation units each having a gas turbine, a high-pressure steam turbine, a generator, a compressor and a heat recovery steam generator with a reheater. In its simplest single-shaft form, high-pressure steam is supplied to the high-pressure steam turbine and exhaust steam there from is supplied to a reheater of the HRSG. Intermediate-pressure steam from the intermediate section of the HRSG combines with the cold reheat steam for heating in the reheater section. The hot reheat steam is supplied from each power generation unit to the inlet of an intermediate pressure steam turbine. Low-pressure steam from a low-pressure section of the HRSG is supplied to a header where it combines with exhaust steam from the intermediate-pressure turbine to drive a low-pressure turbine. The intermediate and low-pressure turbines may be coupled to a common generator. The gas turbine may be steam cooled by routing exhaust steam from the high pressure steam turbine to the gas turbine and exhausting spent cooling steam to the intermediate pressure steam turbine.

U.S. Pat. No. 6,269,626 issued to Kim on Aug. 7, 2001 shows a combined cycle cogeneration power plant includes a combustion turbine formed by an inlet for receiving fuel, an inlet for receiving air, a combustor for burning the combustion fuel and the air, and an outlet through which hot gaseous combustion product is released; a regenerative fuel heating system formed by a plurality of heat exchangers for transferring heat to combustion fuel for heating the combustion fuel, and modulating control valves for controlling temperature of the combustion fuel; a heat recovery steam generator (HRSG) connected to the outlet of the combustion turbine for receiving the gaseous combustion product. The HRSG is formed by a plurality of heat exchangers including steam/water drums, each having a surface blow down connection, and evaporators connected to the steam/water drums, a water inlet connected with the heat exchangers of the HRSG, a steam outlet, and a stack for releasing the exhausted gaseous combustion product. A steam turbine is provided, and has a steam inlet for receiving steam from the steam outlet of the HRSG, and an exhaust steam outlet; a condenser is connected to the exhaust steam outlet of the steam turbine for condensing steam to a liquid condensate; at least one pump is provided for supplying the liquid condensate from the condenser to the HRSG; and at least one pump is provided for supplying feed water from at least one drum to the HRSG. A conventional-type power plant with a regenerative fuel heating system is also disclosed.

U.S. Pat. No. 6,050,080 issued to Horner on Apr. 18, 200 shows a system for cooling hot section components of a gas turbine engine. The cooling system includes a plurality of compressors, or compression train, and an intercooler disposed between each adjacent pair of compressors so as to achieve the desired pressure and temperature of the cooling air at reduced shaft power requirements. The first stage of compression may be provided by the booster, or low pressure compressor, of the engine, with the first intercooler receiving all of the air discharging from the booster. After exiting the first intercooler, a first portion of the booster discharge air is routed to the engine high pressure compressor and a second portion is routed to an inlet of the second compressor of the cooling air compression train. The compressed, cooled air exiting the last, downstream one of the compressors is used for cooling at least a first hot section component of the engine.

U.S. Pat. No. 5,313,782 issued to Frutschi et al on May 24, 1994 shows a combined gas/steam power station plant which consists essentially of a fossil-fired gas turbine group and a steam circuit, with an exhaust heat boiler (11) in between, intercooling and reheat are provided to maximize the efficiency. The gas turbine group consists of two compressors (1, 2), of two combustion chambers (7, 9) and of two turbines (8, 10). Downstream of the first compressor (1), there is an intercooler (3) and on the cool side of this is placed an evaporator (4) which is in effective connection with the intercooler. The steam quantity formed in the evaporator (4) is introduced into a turbine (6) of the steam circuit, the result of this being a first improvement in efficiency. Downstream of the first turbine (8), there is a second combustion chamber (9) in which the exhaust gases from the first turbine (8) are processed to produce hot gases for the second turbine (10). The large calorific potential still present in the exhaust gases from this second turbine (10) flows through the exhaust heat boiler (11) in which a maximized steam power is produced, the result of which is the second improvement in efficiency.

U.S. Pat. No. 5,664,414 issued to Bronicki et al on September 1997 shows an apparatus for generating power includes a gas turbine unit having a compressor for compressing ambient air and producing compressed air, a combustion chamber to which the compressed air is supplied, a source of relatively high grade fuel for burning in the combustion chamber and producing combustion gases, and a gas turbine connected to generator and to the compressor for expanding the combustion gases and producing exhaust gases. The apparatus further includes a combustor that burns relatively low grade fuel, and produces combustion products, and an indirect contact heat exchanger responsive to the combustion products for heating the compressed air before the latter is applied to the combustion chamber, and for producing cooled combustion products. In addition, an energy converter is provided having an organic working fluid responsive to the exhaust gases for converting heat in the exhaust gases to electricity. Finally, the apparatus of the invention serves to minimize the consumption of high grade fuel in the presence of changes in the heating value of the low grade fuel.

### BRIEF SUMMARY OF THE INVENTION

The present invention is a power producing gas turbine system that makes use of two combustors that burn distinct fuel, one being a relatively cheap fuel like coal in which the exhaust contains particulate or corrosive mater that cannot be delivered into a turbine, and the other fuel being a fuel that can burn clean and be fed into a turbine, and where a heat exchanger is used to transfer heat from the coal burning combustor into the gas stream delivered into the clean burning gas fed into the turbine. The gas stream containing the particulate or corrosive mater is directed into a Heat Recovery Steam Generation in order to use the heat to drive a turbine. Both gas streams burned from the clean fuel and the dirty fuel are used to produce power in a turbine.

### BRIEF DESCRIPTION OF THE SEVERAL VIEWS OF THE DRAWINGS

FIG. 1 shows a first embodiment of the present invention in which a combined cycle power plant includes two combustors that burn a different fuel, and a heat exchanger to transfer heat from an output of one combustor into an input of the other combustor.

FIG. 2 shows a second embodiment of the present invention in which the combined cycle power plant of FIG. 1 includes an intercooler in the compressor assembly.

### DETAILED DESCRIPTION OF THE INVENTION

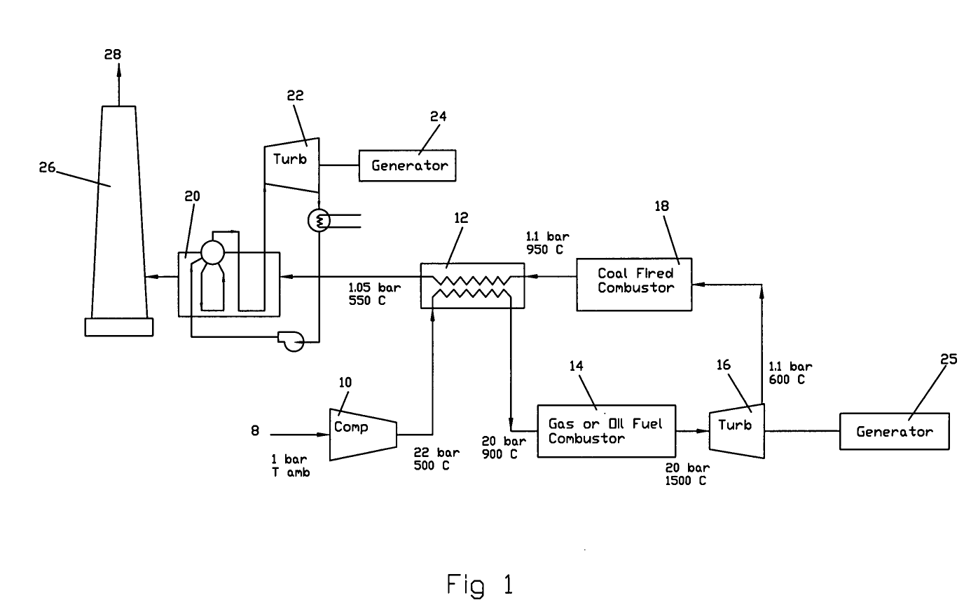

The first embodiment of the present invention is shown in FIG. 1. A compressor 10 draws air 8 at atmospheric pressure and at ambient temperature into the compressor and discharges compressed air at a pressure of 22 bar and at a temperature of 500 C (degrees centigrade) into a heat exchanger 12, where the air picks up heat from a coal or biomass fired combustor 18, which is discharged from the heat exchanger 12 at 20 bar and 900 C. The air at 20 bar and 900 C is then directed into a Combustor 14 which is fueled by Gas, Fuel Oil, synthetic gas, or any fuel that does not leave a particulate or a corrosive matter that can damage a turbine. The air discharged from the Combustor 14 is at 20 bar and 1500 C, and is directed into a Turbine 16 which drives an electrical generator 25 to extract power. The Turbine 16 discharges the air at 1.1 bar and 600 C.

Air from the Turbine 16 is discharged into a Second Combustor 18 which uses a different type of fuel than the First Combustor 14. The Second Combustor is a Coal Fired Combustor, but can also be a Biomass Combustor or a Solar Collector. The fuel for the second combustor can be a relatively cheap fuel compared to that used in the first combustor 16 because the combustion product does not pass into a turbine and therefore can contain particulate or corrosive matter. The fuel used in the first combustor is relatively expensive for this reason. The air discharged from the Second Combustor 18 is at a pressure of 1.1 bar and at a temperature of 950 C, and is directed into the Heat Exchanger 12. The air discharged from the heat exchanger is at 1.05 bar and 500 C, and is directed into a Heat Recovery Steam Generator 20, or HRSG. Because of fuel used in the second combustor 18 produces a particulate or corrosive matter in the combustion gas, it is not delivered to a gas turbine. However, it is passed through a heat exchanger to make use of the heat generation from the coal to drive a gas turbine 16. The heat exchanger cannot operate above a certain temperature due to the metallic materials used in its construction.

The HRSG 20 takes the hot air from the Heat Exchanger 12, which is at a pressure of 1.05 bar and a temperature of 500 C, and produces steam, the steam then being delivered into a Steam Turbine 22 to produce electrical power by driving a Generator 24. The exhaust air passing from the Heat Exchanger 12 and through the HRSG 20 is directed into a smoke stack 26 and discharged into the atmosphere 28.

Because the fuel used in the first combustor 14 is of high cost, heat from the second combustor 18 is transferred to the first combustor through the heat exchanger 12. Since the second combustor 18 uses a fuel that produces particulate matter in the combustion gas, it cannot be used directly in the gas turbine engine because the particulate or corrosive matter will damage the turbine. Thus, the present invention allows for the use of a relatively cheap fuel (like coal) that contains damaging particulate material in the combustion gas to be used in a gas turbine. In the present invention, the generator 25 driven by the gas or oil fired turbine 16 will produce about 67% of the overall power production, the generator 24 driven by the HRSG driven turbine 22 will produce the remaining 33% power production.

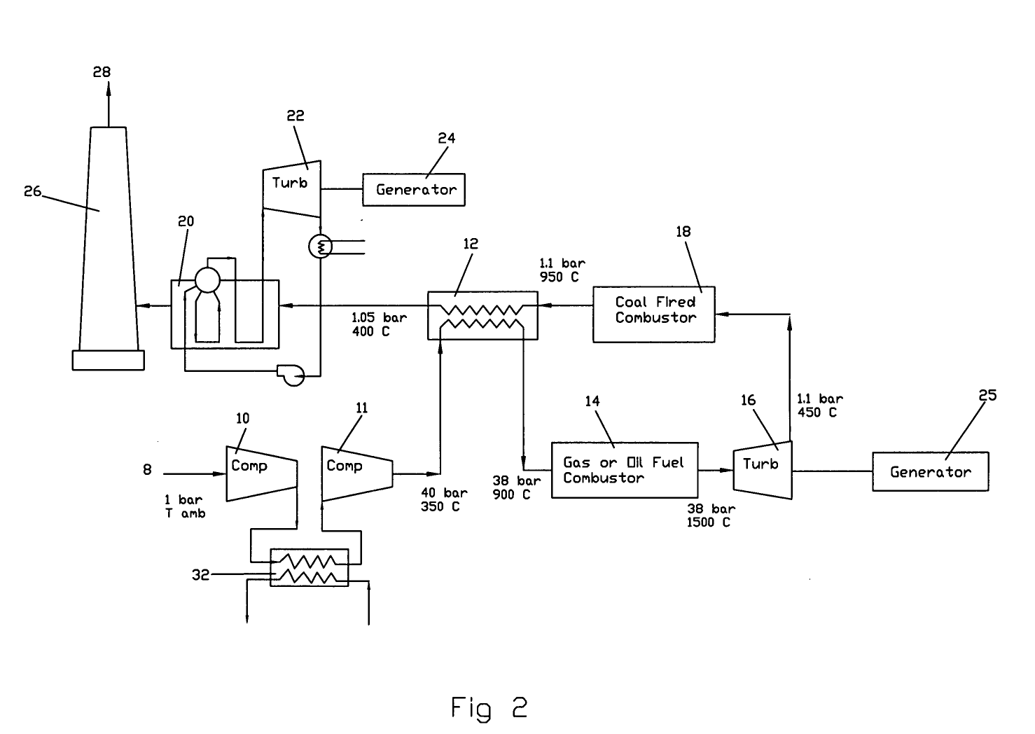

The second embodiment of the present invention is shown in FIG. 2. The second embodiment uses an Intercooler 32 in the Compressor assembly, which is made up of a First Compressor 10 and a Second Compressor 11. With the Intercooler, the air discharged from the Second Compressor 11 is at 40 bar and 350 C, passes through the heat exchanger 12 in which the air is heated to 900 C and with a slight pressure drop to 38 bar. The air then enters the gas or fuel oil combustor 14 where it is heated to 1500 C at a pressure of 38 bar. Energy in the air is then withdrawn by a turbine 16 that drives a generator 25.

The coal fired combustor 18 is the primary fuel used to generate heat in this invention. The gas or fuel oil combustor 14 is the secondary source of heat used in a secondary combustor. In both embodiments of FIGS. 1 and 2, the turbine 16 can also be used to drive the compressor 10 in FIG. 1 or the compressor assembly 10 and 11 in FIG. 2.

In the present invention, the coal fired combustor is a particulate combustor, the particulate fuel combustor being defined as a combustor that burns a fuel that results in a combustion product gas stream which contains some sort of particulate material that would damage a turbine. The gas or fuel oil combustor is defined to be a non-particulate fuel combustor and is considered to be a combustor that burns a clean fuel such as natural gas that results in a combustion product gas stream that does not contain particulate matter that would damage the turbine.

The present invention envisions the use of a metal material heat exchanger, since prior art ceramic heat exchangers are not known yet that use a ceramic material that provides high heat transfer rates similar to that found in a metal material heat exchanger, and is a ceramic material of relatively low cost such that the ceramic heat exchanger can be used in a cost effective manner. If a ceramic material can be found that would have a relatively high heat transfer rate and would be cost effective as compared to a metal material heat exchanger, then the use of this new ceramic material heat exchanger could be used in place of the disclosed metal material heat exchanger.

I claim the following:

1. A power plant, comprising:
A non-particulate combustor for burning a fuel having substantially no particulate matter in the combustion gas;
A compressor means to supply a compressed air to the non-particulate combustor;
A first turbine to receive the combustion gas from the non-particulate combustor;
A particulate combustor for burning a fuel containing a particulate matter in the combustion gas;
A heat exchanger located downstream in the gas path from the particulate combustor, the heat exchanger transferring heat from the particulate combustion gas to the compressed air delivered to the non-particulate combustor;
Steam production means located downstream from the heat exchanger to produce steam from the non-particulate combustion gas; and, A second turbine to receive the steam from the steam production means.

2. The power plant of claim 1, and further comprising:
Gas stream connection means to connect an outlet of the first turbine to an inlet of the particulate combustor.

3. The power plant of claim 1, and further comprising:
The compressor means comprising a first compressor.

4. The power plant of claim 3, and further comprising:
The compressor means comprising a second compressor, an outlet of the second compressor being connected to an inlet of the first compressor; and,
An intercooler connected between the first compressor and the second compressor to cool the compressed air delivered from the second compressor to the first compressor.

5. The power plant of claim 1, and further comprising:
The first turbine being connected to a first electric generator; and,
The second turbine being connected to a second electric generator.

6. The power plant of claim 5, and further comprising:
The first turbine also being connected to the compressor means to drive the compressor means.

7. The power plant of claim 1, and further comprising:
A smoke stack means connected to the steam production means to direct the combustion gas from the particulate combustor into the atmosphere after the combustion gas passes through the steam production means.

8. The power plant of claim 1, and further comprising:
The steam production means being a heat recovery steam generator.

9. The power plant of claim 1, and further comprising:
The heat exchanger being a metallic material heat exchanger.

10. A process for producing electric power in a power plant having a particulate combustor for burning a fuel containing a particulate matter and a non-particulate combustor for burning a fuel containing substantially no particulate matter, the process comprising the steps of:
Delivering compressed air to the non-particulate combustor;
Combusting a non-particulate containing fuel in the non-particulate combustor;
Delivering the combustion product of the non-particulate combustor to a first turbine;
Combusting a particulate containing fuel in the particulate combustor;
Passing the combustion product of the particulate combustor through a heat exchanger;
Transferring heat in the heat exchanger from the particulate combustion product to the compressed air to be delivered to the non-particulate combustor;
Delivering the particulate combustor product from the heat exchanger to a steam generation means to produce steam; and,
Delivering the steam generated in the steam production means to a second turbine.

11. The process for producing power of claim 10, and further comprising the step of:
Providing the compressed air to the non-particulate combustor from a compressor assembly having an intercooler.

12. The process for producing power of claim 10, and further comprising the step of:
Providing for a heat recovery steam generator to produce the steam.

13. The process for producing power of claim 10, and further comprising the steps of:
Burning coal in the particulate combustor; and,
Burning a hydrocarbon based fuel in the non-particulate combustor.

14. The process for producing power of claim 10, and further comprising the step of:
Providing for the heat exchanger to be a metallic material heat exchanger.
